(19) United States
(12) Patent Application Publication
(10) Pub. No.: US 2009/0002114 A1
(43) Pub. Date: Jan. 1, 2009

(54) INTEGRATED INDUCTOR

(76) Inventors: Ming-Tzong Yang, Hsinchu County (TW); Kuei-Ti Chan, Hsinchu City (TW); Ching-Chung Ko, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/768,199

(22) Filed: Jun. 26, 2007

(51) Int. Cl. H01F 5/00

(52) U.S. Cl. 336/200

(57) ABSTRACT

An integrated inductor has a winding. The winding includes a first level metal layer inlaid in a first dielectric layer, a second level metal layer inlaid in a second dielectric layer above the first dielectric layer, and a first line-shaped via structure inlaid in a slot of a third dielectric layer interposed between the first and second dielectric layers for interconnecting the first and second level metal layers.

### BACKGROUND OF THE INVENTION

1. Field of the Invention

The invention generally relates to the field of semiconductor integrated circuit design, and more particularly, to an on-chip high-Q (high quality factor) integrated inductor structure that is cost-effective and is especially suited for RF applications.

2. Description of the Prior Art

The fast growing of the wireless market has created an urgent demand for smaller and cheaper handsets with increased functionality and performance. A major trend of circuit design is to incorporate as many circuit components into integrated circuit form as possible, whereby cost per wafer can be reduced.

Inductors built in semiconductor wafers are widely used in CMOS based radio frequency (RF) circuits such as low-noise amplifiers, voltage-controlled oscillators and power amplifiers. An inductor is a passive electronic component that stores energy in the form of a magnetic field, and an inductor tends to resist any change in the amount of current flowing through it.

One of the most important characteristics of the inductor is the quality factor Q, which relates to the performance of the RF circuits and systems. The quality factor Q of an integrated circuit is limited by parasitic losses within the substrate itself. These losses include high resistance through metal layers of the inductor itself. Consequently, in order to achieve a high quality factor, resistance within the inductor should be held to a minimum. One approach to minimizing the resistance of the inductor is increasing the thickness of metal used to fabricate the inductor.

Therefore, integrated inductors fabricated by RF baseline process may have decreased resistance due to much thicker top metal layer (i.e., the topmost level of the damascene copper interconnection). Because of it is easier for one of the skilled in the art to implement a much thicker top metal layer than other metal layers. Taking 0.13 μm RF baseline process as an example, a top metal layer with a thickness of as high as 3 μm is a commonplace. However, such ultra thick metal layer leads to complicated process and relatively higher cost.

### SUMMARY OF THE INVENTION

It is one object of the invention to provide a monolithic integrated inductor with simple process, low cost and high Q factor.

According to the claimed invention, an integrated inductor has a winding is provided. The winding includes a first level metal layer inlaid in a first dielectric layer, a second level metal layer inlaid in a second dielectric layer above the first dielectric layer, and a first line-shaped via structure inlaid in a slot of a third dielectric layer interposed between the first and second dielectric layers for interconnecting the first and second level metal layers. The winding further comprises an aluminum layer interconnected to the underlying second level metal layer through a second line-shaped via structure. The second line-shaped via structure is inlaid in an insulating layer above the second dielectric layer and is integral with the aluminum layer that is patterned above the insulating layer.

These and other objectives of the invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 illustrates a top view of an exemplary inductor according to this invention; and

FIG. 2 is a sectional perspective view taken along line I-I′ of FIG. 1 according to this invention.

### DETAILED DESCRIPTION

The invention pertains to an improved integrated inductor structure capable of improving the quality factor Q and reducing manufacture cost thereof. From one aspect, the invention uses line-shaped via structure, instead of hole-shaped via plug, for electrically connecting an upper level metal with a lower level metal. Conventionally, there are many via plugs deposed between conductive layers in a semiconductor device for electrically connection the conductive layers. In order to keep process uniformity, the conventional hole-shaped via plugs have a uniform shape and size. Therefore, for the sake of reduce resistance, an array of via plugs is utilized.

From another aspect of the invention, a layer of metal, such as aluminum, over the passivation layer of the integrated circuit chip is employed to fabricate the integrated inductor such that the topmost copper metal layer of the integrated circuit chip has a reduced thickness.

The layer of aluminum disposed over the passivation layer is typically used to provide a bondable interface atop a copper bond pad formed in the topmost copper metal layer of the integrated circuit chip in order to prevent oxidation of the underlying copper material.

The preferred embodiments of this invention will now be explained with the accompanying figures. Throughout the specification and drawings, the symbol “Mn” refers to the topmost level of the metal layers, such as copper layers, fabricated in the integrated circuit chip, while “Mₙ₋₁” refers to the copper metal layer that is just one level lower than the topmost copper metal layer and so on, wherein, preferably, n ranges between 4 and 8 (n=4−8), but not limited thereto. The symbol “V” refers to the via plug between two adjacent copper metal layers. For example, V5 refers to the via plug interconnecting M5 to M6.

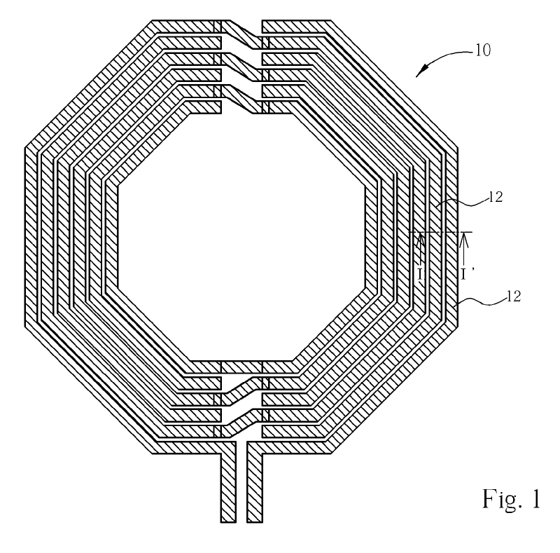

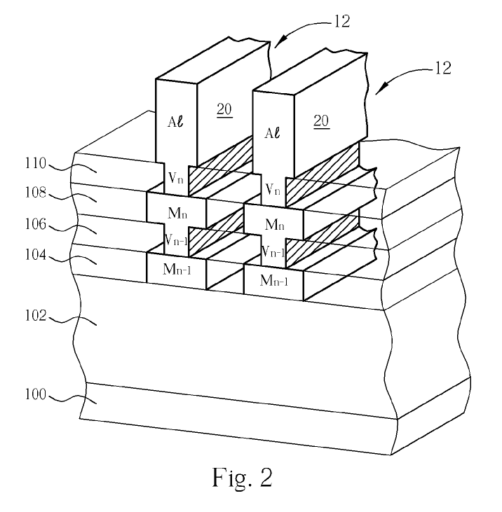

FIG. 1 illustrates a top view of an exemplary differential inductor 10 with multi-turn windings according to this invention. FIG. 2 is a sectional perspective view taken along line I-I′ of FIG. 1 in accordance with one preferred embodiment of this invention. For the sake of simplicity, only two neighboring windings 12 of the differential pair are shown in FIG. 2.

It is understood that although the integrated inductor 10 of the embodiment is demonstrated in the form of octagon shape. The integrated inductor can also be formed of any other suitable shapes, for example, spiral shape, and the shape or pattern in which the inductor is realized is not meant to be any limit. The invention is also applicable to single-ended type inductors.

As shown in FIG. 1 and FIG. 2, each winding 12 of the integrated inductor 10 having a vertical metal stack includes, in the order of, metal layer Mₙ₋₁, via plug layer Vₙ₋₁, metal layer Mₙ, via plug layer Vₙ and an aluminum layer 20. The via plug layer Vₙ₋₁ electrically connects the metal layer Mₙ₋₁ to the overlying metal layer Mₙ, while the via plug layer Vₙ electrically connects the metal layer Mₙ to the overlying aluminum layer 20. According to the preferred embodiment, the winding 12 of the integrated inductor 10 does not include lower metal levels M₁˜Mₙ₋₂ in order to reduce parasitic coupling to the substrate 100. According to another preferred embodiment, the lower metal levels M₁˜M₂ are not included.

One germane feature of this invention is that the via plug layer Vₙ₋₁ and the via plug layer Vₙ are both line-shaped. Preferably, the line-shaped via plug layer Vₙ₋₁ and the line-shaped via plug layer Vₙ substantially have identical patterns with the metal layer Mₙ₋₁, metal layer Mₙ, and the aluminum layer 20, and have a line width that is slightly smaller than the line width of the metal layer Mₙ₋₁ or metal layer Mₙ. By employing the line-shaped via plug layer Vₙ₋₁ and the line-shaped via plug layer Vₙ, the resistance value of the integrated inductor is reduced. In this embodiment, the smaller line width of the line-shaped via plug is not intended to be a limitation of the invention. In another embodiment, the line width of the line-shaped via plug may be equal to or greater than the line width of the metal layer. Further, the shape of the line-shaped via plug of above mentioned substantially identical patterns is not intended to be a limitation of the invention. In another embodiment, the pattern of the line-shaped via plug may include several segmented line-shaped patterns per winding.

According to the preferred embodiment, the metal layer Mₙ₋₁, via plug layer Vₙ₋₁ and metal layer Mₙ are formed by conventional copper damascene methods such as single damascene methods or dual damascene methods. For example, the metal layer Mₙ₋₁ is formed by single damascene methods, while the metal layer Mₙ and the integral via plug layer Vₙ₋₁ are formed by dual damascene methods. Therefore, the metal layer Mₙ and the via plug layer Vₙ₋₁ are unitary.

As known in the art, the copper damascene methods provide a solution to form a conductive wire coupled with an integral via plug without the need of dry etching copper. Either a single damascene or a dual damascene structure may be used to connect devices and/or wires of an integrated circuit.

Generally, the dual damascene process can be sub-classified into trench-first, via-first, partial-via-first and self-aligned processes. By way of example, one conventional method of fabricating a dual damascene structure is to etch dielectric layers to form a trench and a via hole. The via hole and the trench are lined with barrier such as Ta or TaN and then filled with copper. A planarization process such as CMP is then performed to form the damascened metal interconnects.

A multi-layers of dielectric 102˜110 are provided on the substrate 100. According to the preferred embodiment, the integrated inductor 10 is basically fabricated above the dielectric layer 102 that is interposed between the overlying dielectric layer 104 and the substrate 100. The metal layer Mₙ₋₁ is inlaid into the dielectric layer 104. The metal layer Mₙ and the integral via plug layer Vₙ₋₁ are inlaid into the dielectric layers 108 and 106, respectively.

The dielectric layers 102-108 may comprise silicon oxide, silicon nitride, silicon carbide, silicon oxy-nitride, low-k or ultra low-k (ULK) materials such as organic (e.g., SiLK) or inorganic (e.g., HSQ).

According to the preferred embodiment, the via plug layer Vₙ is comprised of aluminum and is integral with the aluminum layer 20. That is, the via plug layer Vₙ and the aluminum layer 20 are unitary. Structurally, the via plug layer Vₙ is inlaid into a corresponding via slot (not explicitly shown) formed in an insulating layer 110 and the aluminum layer 20 is patterned above the insulating layer 110. The via plug layer Vₙ and the aluminum layer 20 can be formed concurrently with the conventional re-distribution layer (not shown).

The insulating layer 110 may be silicon oxide, silicon nitride, silicon carbide, silicon oxy-nitride, polyimide or the like.

The integrated inductor 10 is fully compatible with standard logic processes and does not contain an ultra-thick copper layer due to that the integral via plug layer Vₙ and the aluminum layer 20 are incorporated.

In another preferred embodiment, by employing the line-shaped via plug layer, the resistance value of the integrated inductor is reduced. The high Q integrated inductor can be achieved by a vertical metal stack including, in the order of, metal layer Mₙ₋₁, via plug layer Vₙ₋₁, and metal layer Mₙ. Also, the high Q integrated inductor can be achieved by a vertical metal stack including, in the order of, top copper layer Mₙ, via plug layer Vₙ and aluminum layer.

Those skilled in the art will readily observe that numerous modifications and alterations of the device and method may be made while retaining the teachings of the invention.

1. An integrated inductor comprising a winding, wherein said winding comprises a first copper metal layer inlaid in a first dielectric layer and an aluminum layer over an insulating layer, wherein said aluminum layer is interconnected with said first copper metal layer through an aluminum via structure.

2. (canceled)

3. (canceled)

4. The integrated inductor according to claim 1 wherein said winding further comprises a second copper metal layer inlaid in a second dielectric layer under said first dielectric layer and a line-shaped via structure inlaid in a slot of a third dielectric layer interposed between said first and second dielectric layers for interconnecting said first and second copper metal layers, wherein said first copper metal layer and said line-shaped via structure are unitary.

5. The integrated inductor according to claim 4 wherein said first copper metal layer and said line-shaped via structure are formed by copper dual damascene methods.

6. The integrated inductor according to claim 4 wherein said first dielectric layer comprises silicon oxide, silicon nitride, silicon carbide, silicon oxy-nitride, low-k or ultra low-k materials.

7. The integrated inductor according to claim 4 wherein said second dielectric layer comprises silicon oxide, silicon nitride, silicon carbide, silicon oxy-nitride, low-k or ultra low-k materials.

8. The integrated inductor according to claim 4 wherein said first and second copper metal layers and said line-shaped via structure have substantially identical patterns.

9. The integrated inductor according to claim 8 wherein said identical patterns comprise octagon shape and spiral shape.

10. The integrated inductor according to claim 1 wherein said aluminum via structure comprises a line-shaped via structure inlaid in a slot of said insulating layer.

11. The integrated inductor according to claim 1 wherein said aluminum via structure is inlaid in said insulating layer and said insulating layer is disposed above said first dielectric layer.

12. The integrated inductor according to claim 11 wherein said insulating layer comprises silicon oxide, silicon nitride, silicon carbide, silicon oxy-nitride or polyimide.

13. (canceled)

14. (canceled)

15. The integrated inductor according to claim 1 wherein aluminum via structure has segmented line-shaped patterns.
